(19) United States
(12) Patent Application Publication
(10) Pub. No.: US 2007/0007737 A1
(43) Pub. Date: Jan. 11, 2007

(54) Suspension systems

(76) Inventor: Douglas C. Dayton, Harvard, MA (US)

Correspondence Address: FISH & RICHARDSON PC, P.O. BOX 1022, MINNEAPOLIS, MN, 55440-1022, US

(21) Appl. No.: 11/448,652

(22) Filed: Jun. 7, 2006

Related U.S. Application Data
(60) Provisional application No. 60/697,179, filed on Jul. 7, 2005.

(51) Int. Cl. B62B 7/06

(52) U.S. Cl. 280/37

(57) ABSTRACT

A wheeled luggage device includes a main body defining a compartment therein for containing goods to be transported. At least one wheel is disposed at a lower end of the body when the transport device is in an operative, inclined position. A fluid displacement system is configured to extend the wheel away from the body and/or to provide the wheel with a level of suspension.

### CROSS-REFERENCE TO RELATED APPLICATIONS

This application claims the benefit of U.S. Provisional Application No. 60/697,179, filed Jul. 7, 2005, and entitled “Suspension Systems”, which is incorporated by reference herein.

### TECHNICAL FIELD

This invention relates to suspension systems.

### BACKGROUND

Luggage devices can include wheels for making transport of the luggage easier for the user. Luggage devices commonly include wheels along a base of the device and a handle extending from the upper portion of the device to allow the user to tote the luggage by grasping the handle and wheeling the luggage along a surface.

### SUMMARY

In one aspect of the invention, a wheeled transport device is configured to be manually wheeled in an inclined position by a pedestrian user. The transport device includes a body and a handle extending from the body. The handle is manually graspable by the pedestrian user while walking. The wheeled transport device further includes at least one wheel disposed at a lower end of the body when the transport device is in an operative, inclined position. The wheel is secured to the body for rotation along a surface upon which the user is walking. The wheeled transport device also includes a fluid displacement system that is operatively associated with the wheel such that the wheel is moved away from the body when fluid within the fluid displacement system is displaced in a first direction.

In an additional aspect of the invention, a wheeled transport device configured to be manually wheeled in an inclined position by a pedestrian user includes a body and a handle extending from the body. The handle is manually graspable by the pedestrian user while walking. At least one wheel is disposed at a lower end of the body when the transport device is in an operative, inclined position. The wheel is secured to the body for rotation along a surface upon which the user is walking. A fluid suspension device is operatively associated with the wheel to provide the wheel with a level of suspension.

In another aspect of the invention, a wheeled luggage device configured to be manually wheeled in an inclined position by a pedestrian user includes a main body defining a compartment therein for containing goods to be transported. A handle is disposed at an upper end of the body when the transport device is in an operative, inclined position. The handle is manually graspable by the pedestrian user while walking. At least one wheel is disposed at a lower end of the body when the transport device is in an operative, inclined position. A suspension system secures the wheel to the body. The suspension system includes a suspension device having a member operatively associated with the wheel, and a fluid delivery device in fluid communication with the suspension device. The fluid delivery device is configured to deliver fluid to the suspension device to actuate the member of the suspension device, providing the wheel with a level of suspension.

In a further aspect of the invention, a wheeled luggage device configured to be manually wheeled in an inclined position by a pedestrian user includes a main body defining a compartment therein for containing goods to be transported. A handle is disposed at an upper end of the body when the transport device is in an operative, inclined position. The handle is manually graspable by the pedestrian user while walking. The handle is adapted to retract within the body, and is configured to be fixed in one or more positions between a first, fully retracted position and a second, fully extended position. At least one wheel is disposed at a lower end of the body when the transport device is in an operative, inclined position. A suspension device secures the wheel to the body. The suspension device is operatively associated with the wheel to provide the wheel with a level of suspension, which is a function of the position of the handle.

In yet another aspect of the invention, a suspension system for a wheel of a wheeled transport device includes a suspension device. The suspension device includes a fluid-tight cylinder, a piston movably disposed within the fluid-tight cylinder, a member attached to the piston and operatively associated with the wheel, and a fluid delivery device in fluid communication with the fluid-tight cylinder. The fluid delivery device is configured to deliver fluid within a first region of the fluid-tight cylinder on a first axial side of the piston, and within a second region of the fluid-tight cylinder on a second axial side of the piston.

Embodiments can include one or more of the following features.

In some embodiments, the fluid displacement system is operatively associated with the wheel such that the wheel is moved toward the body when the fluid within the fluid displacement system is displaced in a second direction.

In certain embodiments, the wheeled transport device further includes a member extending from the wheel. The member is configured to move the wheel relative to the body when the fluid within the fluid displacement system is displaced.

In some embodiments, the fluid displacement system includes a fluid cylinder, and the member includes a first end movably positioned within the fluid cylinder and a second end attached to the wheel.

In certain embodiments, the first end of the member is arranged within the fluid cylinder in a substantially fluid-tight configuration.

In some embodiments, the member includes a piston.

In certain embodiments, the handle is moveable between at least a first position and a second position.

In some embodiments, the first position is a fully retracted position of the handle, and the second position is a fully extended position of the handle.

In certain embodiments, the fluid displacement system includes a fluid cylinder operatively associated with the moveable handle such that moving the handle displaces fluid within the fluid displacement system, thereby moving the wheel.

In some embodiments, the wheel is prevented from substantially moving toward the body after the wheel is extended away from the body to a predetermined distance.

In some embodiments, the fluid suspension device includes a pneumatic suspension device.

In certain embodiments, the fluid suspension device includes a hydraulic suspension device.

In some embodiments, the wheeled transport device includes a luggage device.

In certain embodiments, the wheeled transport device includes a plurality of wheels, each of the wheels being operatively associated with an independent fluid suspension device.

In some embodiments, the handle is collapsible for storage.

In certain embodiments, the handle is telescoping.

In some embodiments, the wheel is interconnected to the collapsible handle, such that the wheel is retracted when the handle is collapsed.

In certain embodiments, the wheeled transport device further includes a member associated with the suspension device to change the level of suspension.

In some embodiments, the member includes the handle, and the handle is movable between a plurality of positions.

In certain embodiments, the level of suspension is a function of the position of the handle.

In some embodiments, the handle is configured to extend and retract, and the level of suspension increases as the handle is extended and decreases as the handle is retracted.

In certain embodiments, the handle is configured to be fixed in each of the plurality of positions.

In some embodiments, the handle is configured to be fixed in at least three different positions.

In certain embodiments, the fluid suspension device includes a member connected to the wheel.

In some embodiments, the wheeled transport device further includes a fluid delivery device in fluid communication with the suspension device, and the fluid delivery device is configured to actuate the member of the suspension device.

In certain embodiments, the member is configured to be positioned in a plurality of axial positions, each of the axial positions resulting in a different level of suspension.

In some embodiments, the wheeled transport device further includes a valve positioned between the fluid delivery device and the suspension device, the valve being configured to adjust a flow area between the fluid delivery device and the suspension device.

In certain embodiments, the suspension device includes a first piston movably disposed within a first cylinder, and the member is attached to the first piston.

In some embodiments, the fluid delivery device is configured to deliver the fluid to a first side of the first piston to move the member in a first axial direction, and to a second side of the first piston to move the member in a second axial direction.

In certain embodiments, the level of suspension is a function of the axial position of the member.

In some embodiments, the fluid delivery device includes a second piston movably disposed with a second cylinder, and a first end region of the first cylinder is in fluid communication with a first end region of the second cylinder, and a second end region of the first cylinder is in fluid communication with a second end region of the second cylinder.

In certain embodiments, the first and second cylinders are fluidly connected to one another with first and second hoses.

In some embodiments, the wheel is configured to retract into the body.

In certain embodiments, the wheel is configured to retract by actuating the member.

In some embodiments, the handle is movable between at least a first position and a second position, and movement of the handle causes the fluid to be transferred from the fluid delivery device to the suspension device.

In certain embodiments, the fluid delivery device comprises a piston movably disposed within a cylinder, and the handle is attached to the piston.

In some embodiments, the wheel is extended when the handle is in the first position and the wheel is retracted when the handle is in the second position.

In certain embodiments, the handle includes a locking feature that is constructed to cooperate with a locking mechanism of the body to retain the handle in one or more positions intermediate to the first and second positions.

In some embodiments, the wheeled transport device further includes a wheel-driven electric generator that generates electrical power while the device is wheeled along the surface.

In certain embodiments, the wheel has a resilient outer member that directly contacts the surface upon which the device is wheeled.

In some embodiments, the wheeled transport device is in combination with multiple, interchangeable wheels of differing properties.

In certain embodiments, the handle is configured to be fixed in a plurality of different positions.

In some embodiments, the wheeled luggage device further includes a fluid delivery device in fluid communication with the suspension device, and the fluid delivery device is configured to deliver fluid to the suspension device.

In certain embodiments, the fluid delivery device is operatively attached to the handle.

In some embodiments, the suspension device includes a pneumatic suspension device.

Embodiments may include one or more of the following advantages.

In some embodiments, the wheeled transport device (e.g., the luggage device) includes a suspension system (e.g., a pneumatic suspension system). This can help to stabilize the luggage device during transport. The suspension system can, for example, help to prevent the luggage from being overturned by impacts to one or more of the wheels caused by rough surfaces, obstructions, and/or sudden changes in elevation, such as stairs and curbs. This can alternatively or additionally improve the comfort of the user. The suspension system can, for example, help to reduce vibrations transferred from the handle to the user's hand during transport.

In certain embodiments, the luggage device includes a handle and/or wheels that are retractable. This can help to improve the ease with which the luggage device can be stored in confined spaces, such as airliner overhead storage compartments, airport rental storage lockers, and home closets. The size of the luggage device can, for example, be reduced and/or the number of potential impediments protruding from the luggage can be reduced.

Other features and advantages will be apparent from the description, the drawings, and the claims.

### DESCRIPTION OF DRAWINGS

FIG. 1. is a side, cross-sectional view of an embodiment of a wheeled luggage device with a handle and wheel in a retracted position.

FIG. 2 is a side, cross-sectional view of the wheeled luggage device of FIG. 1 with the handle and wheel in an extended position.

FIG. 3 is a side, cross-sectional view of the wheeled luggage device of FIG. 1 with the handle and wheel in an extended position, and arranged at an attitude for transport.

FIG. 4 is a rear, cross-sectional view of an embodiment of a wheeled luggage device with a suspension system including an adjustable valve.

FIG. 5 is a side cross-sectional view of an embodiment of a wheeled luggage device with a retractable handle and a suspension system including a retractable member.

Like reference symbols in the various drawings indicate like elements.

### DETAILED DESCRIPTION

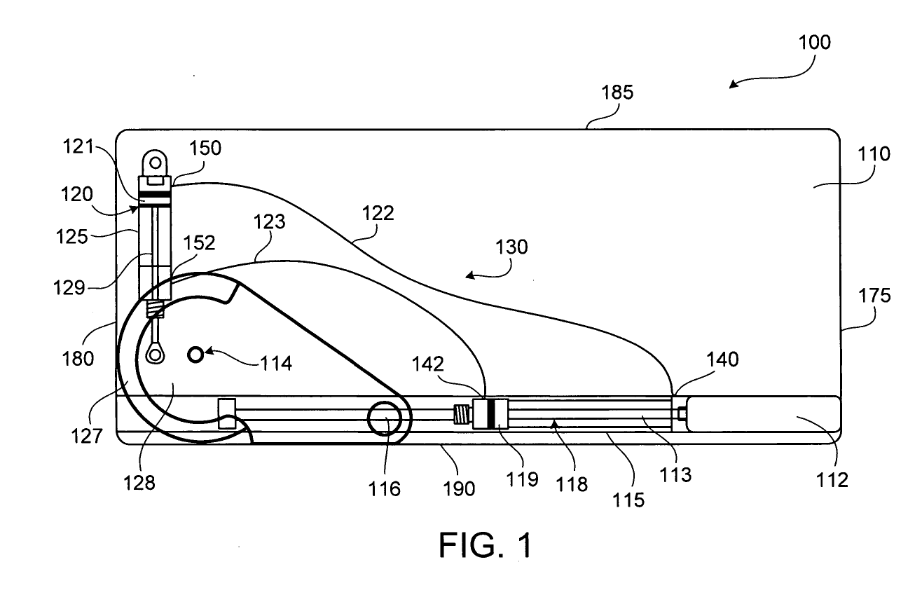

FIG. 1 shows a luggage device 100 in a stored configuration. Luggage device 100 includes a body portion 110 that includes a cavity in which goods (e.g., clothing) can be contained. Luggage device 100 further includes a suspension system 130 having a fluid delivery device 118 and a suspension device 120 that are fluidly connected to one another by hoses 122 and 123. Fluid delivery device 118 is operatively connected to handle 112, and suspension device 120 is operatively attached to a wheel assembly 128. As described below, the retraction and expansion of handle 112 can function to retract and extend, respectively, wheel assembly 114. The retraction and extension of handle 112 can also increase and decrease, respectively, the level of suspension (e.g., the effective spring coefficient) provided by suspension system 130.

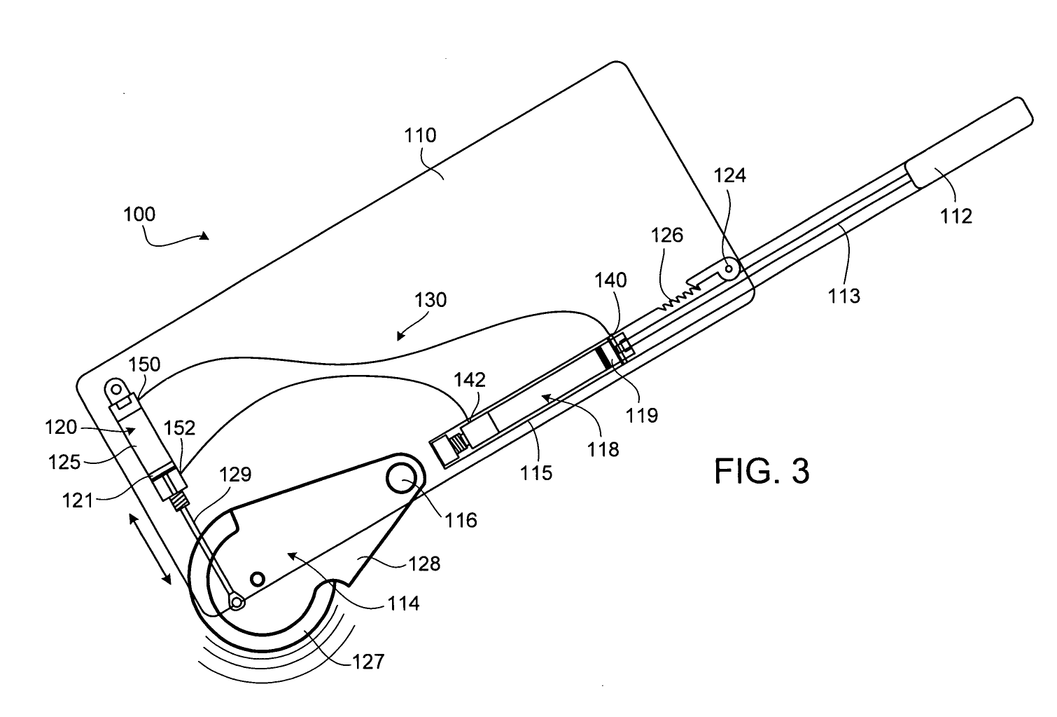

Handle 112, as shown in FIG. 1, is collapsed into body portion 110 of luggage device 100 on a telescoping rail as is customary in the wheeled luggage industry with the grasping member of the handle flush to the top surface of the bag. A member 113 extends from the bottom end of handle 112 and attaches to a piston 119 within fluid delivery device 118. Thus, piston 119 can be moved along the longitudinal axis of fluid delivery device 118 in response to movement (e.g., extension or retraction) of handle 112, as discussed below. Referring briefly to FIG. 3, handle 112 includes multiple teeth 126 along its length. Teeth 126 can cooperate with a locking mechanism 124 of body 110 in order to retain handle 112 in a fixed extended position. Teeth 126 can, for example, contact a mating surface of locking mechanism 124 to prevent handle 112 from being extended beyond a predetermined point. Teeth 126 can alternatively or additionally cooperate with surfaces of locking mechanism 124 to prevent handle 112 from being retracted beyond a predetermined point. While locking mechanism 124 has been described as a tooth-engaging mechanism, the locking mechanism can be any device capable of retaining handle 112 in a fixed axial position. Examples of locking mechanisms include friction devices (e.g., cams, rollers and clutches, clamps and collets, magnets, magnetic assemblies), interference devices (e.g., pins, pawls, latches, hook and loop fasteners), fluid couplings, and thermal clutches, among other mechanisms. Alternatively or additionally, any of various materials, such as magnetorheological fluid, can be used to help provide locking action.

Referring again to FIG. 1, wheel assembly 114 includes a wheel 127 that is retractably attached to a wheel housing 128. Wheel 127 can, for example, be disposed about a shaft or axel extending from wheel housing 128. Wheel 127 can be formed of any of various types of materials, such as plastics and/or metals. In certain embodiments, the wheel is formed of an elastomeric material and includes molded internal ribs that resiliently deform when loaded, both providing effective springing of the load and providing damping of the system. In some embodiments, the luggage device includes multiple interchangeable wheels. In certain embodiments, wheel 127 can be one of a number of interchangeable wheels, each of which has different mechanical properties that effect the suspension of luggage device 100. In such embodiments, for example, the user can select a wheel based on various factors that might effect the suspension of luggage device 100, such as size of luggage device 100, weight of luggage device 100, and load distribution within luggage device 100.

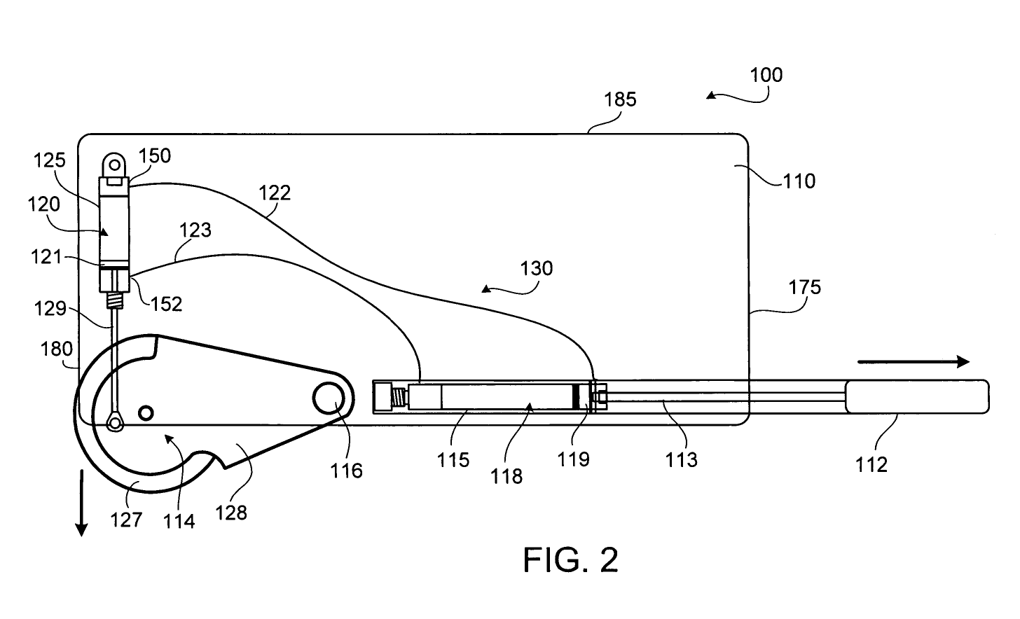

A member 129 extends from wheel housing 128 and attaches to a piston 121 disposed within suspension device 120. Thus, piston 121 can move along the longitudinal axis of suspension device 120 in response to inward or outward movement of wheel assembly 114 (e.g., wheel housing 128 of wheel assembly 114), as discussed below. Wheel housing 128 is attached to body portion 110 with a hinge 116. Wheel housing 128 is configured to pivot or rotate about hinge 116 such that wheel assembly 114 can be retracted into body portion 110, as shown in FIG. 1, or extended away from body portion 110, as shown in FIG. 2.

Handle 112 and wheel 114 are operatively connected to one another by suspension system 130. As discussed above, suspension system 130 includes fluid delivery device 118, suspension device 120, and hoses 122 and 123 that fluidly connect fluid delivery device 118 to suspension device 120. As shown in FIG. 1, fluid delivery device 118 includes a cylinder 115 in which piston 119 is movably disposed. A fluid-tight (e.g., air-tight) seal is formed between the outer surface of piston 119 and the inner surface of cylinder 115. Cylinder 115 includes a first fluid passage 140 in the upper region of cylinder 115 (e.g., in the region of cylinder 115 nearer a top wall 175 of luggage device 100), and includes a second fluid passage 142 in the bottom region of cylinder 115 (e.g., in the region of cylinder 115 nearer a bottom wall 180 of luggage device 100). Hoses 122 and 123 are attached to first and second fluid passages 140 and 142 with a fluid-tight seal. Hoses 122 and 123 can be formed of any of various materials, such as plastic, rubber, and/or metal. Any of various techniques can be used to attach hoses 122 to fluid passages 140 and 142. For example, hoses 122 can be attached to fluid passages 140 and 142 using screw couplings, detent balls and/or rings, barbed couplings, swaged fittings, brazed and/or welded connections, thermal shrink, adhesives, and/or sealed pin couplings.

As discussed above, member 113 attaches piston 119 to handle 112. Thus, as handle 112 is axially displaced (e.g., extended or retracted), piston 119 can also be axially displaced. Displacement of piston 119 within cylinder 115 causes the suspension fluid (e.g., air) within the cylinder to be forced out of the cylinder and into hose 122 or hose 123 (depending on direction of the displacement of piston 119) via one of fluid passages 140 and 142. The fluid that exits cylinder 115 is transferred to suspension device 120 via the hose into which it is forced.

Suspension device 120 includes a cylinder 125 in which piston 121 is movably disposed. Piston 121 forms a fluid-tight (e.g., air-tight) seal with cylinder 125 in a manner similar to that described above with respect to piston 119 and cylinder 115 of fluid delivery mechanism 118. Member 129 extends from piston 121 and attaches to wheel housing 128. Member 129 can, for example, be pivotably attached to wheel housing 128. Due to the attachment of member 129 to wheel housing 128, piston 121 can move axially in response to movement of wheel assembly 114 (e.g., wheel housing 128 of wheel assembly 114), and vice versa.

Cylinder 125 includes first and second fluid passages 150 and 152 at its end regions, on opposite axial sides of piston 121. First fluid passage 150, for example, is disposed at the end region of cylinder 125 nearer a front wall 185 of luggage device 100, and second fluid passage 152 is disposed at the end region of cylinder 125 nearer a rear wall 190 of luggage device 100. Hoses 122 and 123 attach to fluid passages 150 and 152, respectively. As a result, a closed fluid loop is formed between fuel delivery device 118 and suspension device 120. Thus, the fluid can be transferred between the various components of suspension system 130 (e.g., between fuel delivery device 118 and suspension device 120), but the fluid is generally prevented from escaping from the system.

As shown in FIG. 1, when handle 112 is retracted within body 110, piston 119 is positioned at the end region of cylinder 115 proximal to fluid passage 142, and piston 121 is positioned at the end region of cylinder 125 proximal to fluid passage 150. When handle 112 is extended to the transport position, as shown in FIG. 2, piston 119 follows handle 112 upward, expelling some of the fluid through fluid passage 140. The expelled fluid is forced through hose 122 causing some of the fluid contained within the system to enter suspension device 120 via fluid passage 150. As the fluid enters cylinder 125 of suspension device 120, piston 121 is forced toward the opposite end of cylinder 125 (e.g., toward wheel assembly 114). As a result, wheel assembly 114 is caused to extend (e.g., pivot) outwardly, away from body 110. With wheel assembly 114 in the extended position, it can provide support for transport of luggage device 100. Wheel 127 can, for example, contact the ground and have room to move up and down about its pivot as loads are applied by interaction with the ground surface.

FIG. 3 shows luggage device 100 in a transport orientation, as when being pulled by the user. Handle 112 and wheel assembly 114 are in the extended position, and body 110 is arranged at an inclined angle relative to the ground surface. Body 110 can, for example, be arranged at an acute angle (e.g., about 15 degrees to about 75 degrees) relative to the ground surface. Forces that are applied to wheel 127 (e.g., by the ground surface) can be absorbed by suspension device 120 in this configuration. When handle 112 is extended, it can be fixed in a desired position (e.g., using locking mechanism 124). With handle 112 in the locked position, piston 119 of fuel delivery device 118 is similarly held in a fixed axial position within cylinder 115 so that the volume occupied by the suspension fluid between fuel delivery device 118 and suspension device 120 (e.g., between piston 119 of fuel delivery device 118 and piston 121 of suspension device 120) is substantially constant. In this configuration, an impact on wheel 114 (e.g., by the ground surface) acts on piston 121 and compresses the suspension fluid between pistons 121 and 119 via hose 122. Consequently, much of the energy resulting from the impact is dissipated before being transferred to body 110 of luggage device 100. Thus, the amount of vibrational energy transferred to the user by body 110 (e.g., via handle 112) can be reduced. Similarly, due to the dissipation of energy by suspension system 130, less energy is available to create an overturning torque, and thus the likelihood of luggage device 100 tipping over can be reduced.

In some embodiments, the level of suspension provided by suspension system 130 can be altered by altering the position of handle 112. The level of suspension can, for example, be increased by increasing the amount that handle 112 is extended, and/or can be decreased by decreasing the amount that handle 112 is extended. In certain embodiments, an initial extension of handle 112 deploys wheel assembly 114, as described above. After wheel assembly 114 has been fully deployed, any additional extension of handle 112 can compress the fluid in hose 122, which can increase the level of suspension (e.g., the effective spring rate) provided to wheel assembly 114 to accommodate a wider range of weights or loads within the luggage. Using locking mechanism 124, handle 112 can be fixed in a position corresponding to a desired suspension level. By locking handle 112, the desired suspension level or effective spring rate can be substantially maintained during use. The effective spring rate of suspension system 130 can, for example, range from about two pounds to about 200 pounds (e.g., about two pounds to about 100 pounds, about two pounds to about 50 pounds, about two pounds to about 25 pounds).

To convert luggage device 100 from its transport configuration (shown in FIG. 3) into its storage configuration (shown in FIG. 1), handle 112 is pushed into body 110. This drives piston 119 of fuel delivery device 118 toward fluid passage 142. As a result, the fluid is forced through hose 123 and into suspension device 120 via fluid passage 152, which causes piston 119 to move axially toward the opposite end of cylinder 125 (e.g., away from wheel assembly 114). Consequently, wheel assembly 114 is retracted into body 110.

While several embodiments have been described, other embodiments are possible.

As an example, while the wheeled transport device has been described as a wheeled luggage device, the wheeled transport device can alternatively or additionally be any of various other wheeled devices that are capable of being transported (e.g., pulled or pushed) by the user. Examples of such devices include pull carts, pushcarts, dollies, trash cans, golf carts, barbeque charcoal or gas grilles, portable concrete mixers, landscaping carts and carryalls, wheeled mosquito capture machines, lounge chairs, portable tables, and other outdoor equipment.

As another example, while the suspension fluid of the embodiments above has been described as being air, any of various other types of fluids can alternatively or additionally be used. Examples of other types of fluid include water, oil, gases (e.g., nitrogen), alcohol, and various derivatives of petroleum.

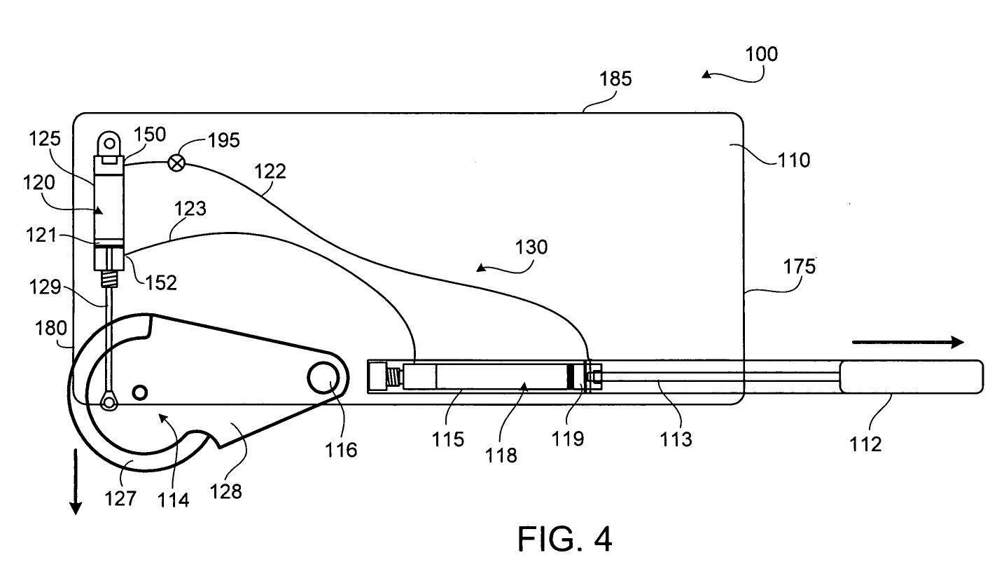

As a further example, in some embodiments, the suspension system includes a valve positioned between the suspension device and the fluid delivery device. The valve can be used to tune the load carrying capability of the suspension device. As shown in FIG. 4, for example, a valve 195 connects hose 122 to cylinder 125 of suspension device 120. Valve 195 can be adjusted to vary the area through which air is allowed to pass between cylinder 125 and tube 122. By controlling the flow area, the rate of flow can be modified. The rate at which the initial pressure acting on piston 121 changes in response to external forces acting on the wheels can, for example, increase as the flow area decreases. Likewise, the rate at which the initial pressure acting on piston 121 changes in response to external forces acting on the wheels can decrease as the flow area increases. Therefore, valve 195 can be adjusted to provide the level of suspension response desired by the user. The user may, for example, adjust the valve based on the type of terrain on which the luggage device is to be used and/or the weight of the luggage device and its contents. Valve 195 can be any of various types of valve devices. Examples of such devices include rotary valves (e.g., multiple-orifice rotary valves), screw valves, gate valves, and plug valves. Alternatively or additionally, an insert having an orifice can positioned within tube 122 in order to alter the flow area. The orifice of the insert can be of any of various shapes and sizes.

As an additional example, while luggage device 100 has been described as having one wheel assembly 114, the luggage device can include two or more wheel assemblies. In some embodiments, each of the wheel assemblies is operatively associated with an independent suspension system. The suspension systems can be similar (e.g., identical) to suspension system 130 described above. In certain embodiments, the suspension systems have distinct suspension devices and hoses, but share a common fluid delivery device. The common fluid delivery device can, for example, include two different pairs of air passage. Similarly, two different sets of hoses, one of which leads to one of the wheel assemblies and the other of which leads to the other of the wheel assembles. Alternatively or additionally, the common fluid delivery device can include a single inlet and/or outlet. The single inlet and/or outlet can be fluidly attached to a T-valve, which can direct the fluid to multiple suspension devices.

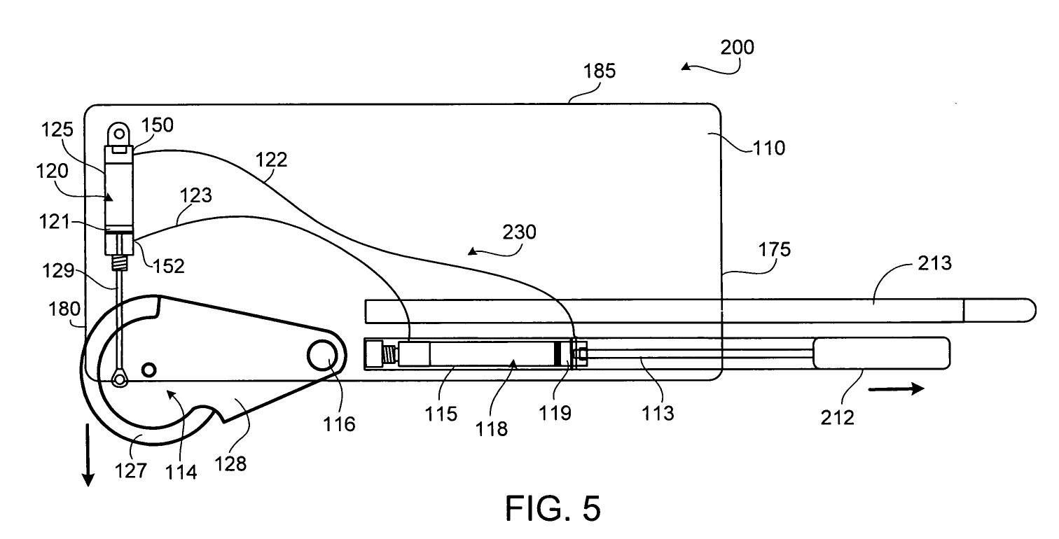

As a further example, while the embodiments above describe the handle of the luggage device as being part of the suspension system, other mechanisms independent of the handle can be used to control the suspension system. As shown in FIG. 5, for example, a luggage device 200 includes a retractable handle 213 in addition to a suspension system 230 including a retractable member 212. Suspension system 230 is similar to suspension system 130 described above. The level of suspension can, for example, be modified by extending or retracting retractable member 212 much like the level of suspension provided by suspension system 130 can be modified by extending or retracting handle 112. However, due to the configuration of suspension system 230, the suspension of luggage device 200 can advantageously be controlled independent of retractable handle 213. Handle 213 can, for example, be adjusted to any of various different positions without substantially affecting the level of suspension provided to luggage device 200. Consequently, the user can select a desired toting position of the handle without modifying the level of suspension of the luggage device.

As another example, while the embodiments above involve human-powered luggage devices, the luggage devices can alternatively or additionally be machine-powered. In some embodiments, for example, the luggage device includes an electric motor, a power source, and a generator. Power can be transferred from the generator to the power source and then from the power source to the motor where it can be used to rotate the wheels. Alternatively or additionally, the generator can be used to provide power to any of various electronic devices of the luggage device. Examples of luggage devices including generators are described in U.S. Patent Application No. 60/599,360, filed Aug. 6, 2004, and entitled “Electrical Power Generation”, which is incorporated by reference herein.

Other embodiments are in the claims.

What is claimed is:

1. A wheeled transport device configured to be manually wheeled in an inclined position by a pedestrian user, the transport device comprising:
a body;
a handle extending from the body, the handle manually graspable by the pedestrian user while walking;
at least one wheel disposed at a lower end of the body when the transport device is in an operative, inclined position, the wheel being secured to the body for rotation along a surface upon which the user is walking; and
a fluid displacement system operatively associated with the wheel such that the wheel is moved away from the body when fluid within the fluid displacement system is displaced in a first direction.

2. The wheeled transport device of claim 1, wherein the wheeled transport device comprises a wheeled luggage device.

3. The wheeled transport device of claim 1, wherein the fluid displacement system is operatively associated with the wheel such that the wheel is moved toward the body when the fluid within the fluid displacement system is displaced in a second direction.

4. The wheeled transport device of claim 1, further comprising a member extending from the wheel, the member being configured to move the wheel relative to the body when the fluid within the fluid displacement system is displaced.

5. The wheeled transport device of claim 4, wherein the fluid displacement system comprises a fluid cylinder, and the member comprises a first end movably positioned within the fluid cylinder and a second end attached to the wheel.

6. The wheeled transport device of claim 5, wherein the first end of the member is arranged within the fluid cylinder in a substantially fluid-tight configuration.

7. The wheeled transport device of claim 4, wherein the member comprises a piston.

8. The wheeled transport device of claim 1, wherein the handle is moveable between at least a fully retracted position and a fully extended position.

9. The wheeled transport device of claim 8, wherein the fluid displacement system comprises a fluid cylinder operatively associated with the moveable handle such that moving the handle displaces fluid within the fluid displacement system, thereby moving the wheel.

10. The wheeled transport device of claim 1, wherein the wheel is prevented from substantially moving toward the body after the wheel is extended away from the body to a predetermined distance.

11. A wheeled transport device configured to be manually wheeled in an inclined position by a pedestrian user, the transport device comprising:
a body;
a handle extending from the body, the handle manually graspable by the pedestrian user while walking;
at least one wheel disposed at a lower end of the body when the transport device is in an operative, inclined position, the wheel being secured to the body for rotation along a surface upon which the user is walking; and
a fluid suspension device operatively associated with the wheel to provide the wheel with a level of suspension.

12. The wheeled transport device of claim 11, wherein the fluid suspension device comprises a pneumatic suspension device.

13. The wheeled transport device of claim 11, wherein the wheeled transport device comprises a luggage device.

14. The wheeled transport device of claim 11, wherein the wheeled transport device comprises a plurality of wheels, each of the wheels being operatively associated with an independent fluid suspension device.

15. The wheeled transport device of claim 11, wherein the handle is collapsible.

16. The wheeled transport device of claim 15, wherein the wheel is interconnected to the handle, such that the wheel is retracted when the handle is collapsed.

17. The wheeled transport device of claim 11, further comprising a member associated with the suspension device and configured to change the level of suspension.

18. The wheeled transport device of claim 17, wherein the member comprises the handle, the handle being movable between a plurality of positions.

19. The wheeled transport device of claim 18, wherein the level of suspension is a function of the position of the handle.

20. The wheeled transport device of claim 19, wherein the handle is configured to extend and retract, and wherein the level of suspension increases as the handle is extended and decreases as the handle is retracted.

21. The wheeled transport device of claim 18, wherein the handle is configured to be fixed in each of the plurality of positions.

22. The wheeled transport device of claim 21, wherein the handle is configured to be fixed in at least three different positions.

23. The wheeled transport device of claim 11, wherein the fluid suspension device comprises a support member, the wheel being connected to the support member.

24. The wheeled transport device of claim 23, wherein the support member is configured to be positioned in a plurality of axial positions, each of the axial positions resulting in a different level of suspension.

25. The wheeled transport device of claim 23, further comprising a fluid delivery device in fluid communication with the suspension device, the fluid delivery device configured to actuate the support member.

26. The wheeled transport device of claim 25, further comprising a valve positioned between the fluid delivery device and the suspension device, the valve being configured to adjust a flow area between the fluid delivery device and the suspension device.

27. The wheeled transport device of claim 23, wherein the suspension device comprises a first piston movably disposed within a first cylinder, the support member being attached to the first piston.

28. The wheeled transport device of claim 27, wherein the fluid delivery device is configured to deliver the fluid to a first side of the first piston to move the support member in a first axial direction, and to a second side of the first piston to move the support member in a second axial direction.

29. The wheeled transport device of claim 28, wherein the level of suspension is a function of the axial position of the support member.

30. The wheeled transport device of any of claim 27, wherein the fluid delivery device comprises a second piston movably disposed within a second cylinder, a first end region of the first cylinder being in fluid communication with a first end region of the second cylinder, and a second end region of the first cylinder being in fluid communication with a second end region of the second cylinder.

31. The wheeled transport device of claim 30, wherein the first and second cylinders are fluidly connected to one another with first and second hoses.

32. The wheeled transport device of claim 23, wherein the wheel is configured to retract into the body.

33. The wheeled transport device of claim 23, wherein the handle is movable between at least a first position and a second position, and wherein movement of the handle causes the fluid to be transferred from the fluid delivery device to the suspension device.

34. The wheeled transport device of claim 33, wherein the fluid delivery device comprises a piston movably disposed within a cylinder, the handle being attached to the piston.

35. The wheeled transport device of claim 33, wherein the wheel is extended when the handle is in the first position and the wheel is retracted when the handle is in the second position.

36. The wheeled transport device of claim 35, wherein the handle comprises a locking feature that is constructed to cooperate with a locking mechanism of the body to retain the handle in one or more positions intermediate to the first and second positions.

37. A suspension system for a wheel of a wheeled transport device, the suspension system comprising:
a fluid-tight cylinder;
a piston movably disposed within the fluid-tight cylinder;
a member attached to the piston and operatively associated with the wheel; and
a fluid delivery device in fluid communication with the fluid-tight cylinder, the fluid delivery device being configured to deliver fluid within a first region of the fluid-tight cylinder on a first axial side of the piston, and within a second region of the fluid-tight cylinder on a second axial side of the piston.
